(19) United States
(12) Patent Application Publication
(10) Pub. No.: US 2026/0080367 A1
(43) Pub. Date: Mar. 19, 2026

(54) SYSTEMS AND METHODS FOR INTEGRATING THIRD PARTY OFFERS FROM MULTIPLE AGGREGATORS INTO A SINGLE MESSAGE

(71) Applicant: JPMORGAN CHASE BANK, N.A., New York, NY (US)

(72) Inventors: Tarang AGARWAL, Fort Worth, TX (US); Paul KOUROUTSIDIS, Downingtown, PA (US); Maxwell EVERS, Wilmington, DE (US)

(21) Appl. No.: 18/885,009

(22) Filed: Sep. 13, 2024

(51) Int. Cl. G06Q 10/107; G06F 40/186; G06Q 30/0601

(52) U.S. Cl. CPC G06Q 10/107; G06F 40/186; G06Q 30/0611

(57) ABSTRACT

A method may include: an email distributor generating an email using a template comprising static content and placeholders for dynamic content and sending the email to a customer using a customer email client; in response to the email being opened: a customer electronic device executing the scripts that call an email content optimizer for the dynamic content; the email content optimizer calling an email experience service with the calls for the dynamic content; the email experience service requesting recommendation engine for the dynamic offer content; the recommendation engine ranking the dynamic content; the email experience service receiving the ranked dynamic content, retrieving metadata for the dynamic content from an offer catalog, combining the ranked dynamic content and the metadata, receiving the combined ranked dynamic content and the metadata, and populating the placeholders in the email template with the dynamic content and the metadata.

### BACKGROUND OF THE INVENTION

### 1. Field of the Invention

Embodiments are generally directed to systems and methods for integrating third party offers from multiple aggregators into a single message.

### 2. Description of the Related Art

Third party offers received by customers in marketing email campaigns are generally serviced directly by a single third-party aggregator. This limits growth as well as the visibility of data for analytics.

### SUMMARY OF THE INVENTION

Systems and methods for integrating third party offers from multiple aggregators into a single message are disclosed. In one embodiment, a method may include: (1) generating, by an email distributor, an email using a template, the template comprising static content and placeholders for dynamic content, the placeholders comprising scripts for calling the dynamic content; (2) sending, by the email distributor, the email to a customer using a customer email client; (3) in response to the email being opened: executing, by a computer processor on a customer electronic device, the scripts, wherein the scripts call an email content optimizer for the dynamic content; calling, by the email content optimizer, an email experience service with the calls for the dynamic content; requesting, by the email experience service, a recommendation engine for the dynamic offer content, wherein the recommendation engine calls a plurality of third-party aggregators for the dynamic content; ranking, by the recommendation engine, the dynamic content; receiving, by the email experience service, the ranked dynamic content; retrieving, by the email experience service, metadata for the dynamic content from an offer catalog; combining, by the email experience service, the ranked dynamic content and the metadata; receiving, by the email content optimizer, the combined ranked dynamic content and the metadata; and populating, by the email content optimizer, the placeholders in the email template with the dynamic content and the metadata.

In one embodiment, the email content optimizer generates a view event in response to the email being opened.

In one embodiment, the method may also include: monitoring, by the email content optimizer, customer interaction with the dynamic content; and sending, by the email content optimizer, an activation event in response to the customer selecting the dynamic content in one of the placeholders.

In one embodiment, the method may also include: redirecting, by the email content optimizer, the customer to an issuer interface; wherein the issuer interface provides terms and conditions for an offer associated with the selected dynamic content.

In one embodiment, the method may also include: training the recommendation engine based on acceptance or rejection of the offer.

In one embodiment, the static content may include images or customer information for the customer.

In one embodiment, each of the scripts may include Application Programming Interface calls for the dynamic content.

In one embodiment, the third-party aggregators identify the dynamic content based on transaction files for the customer received from an issuer.

In one embodiment, the recommendation engine ranks the dynamic content based on the customer's transaction history, offers made to the customer, and offers redeemed by the customer.

In one embodiment, the metadata may include an offer start date, and offer expiration date, details for the offer, and offer vendor information.

According to another embodiment, a system may include: an email distributor that may be configured to generate an email using a template, the template comprising static content and placeholders for dynamic content, the placeholders comprising scripts for calling the dynamic content, and to send email to a customer using a customer email client; a customer electronic device executing an email program; an email content optimizer; an email experience service; a recommendation engine; and a plurality of third-party aggregators. The email program may be configured to execute the scripts in response to the email being opened, wherein the scripts call the email content optimizer for the dynamic content. The email content optimizer may be configured to call an email experience service with the calls for the dynamic content. The email experience service may be configured to call the recommendation engine for the dynamic offer content. The recommendation engine may be configured to call a plurality of third-party aggregators for the dynamic content to rank the dynamic content, to receive the ranked dynamic content, to retrieve metadata for the dynamic content from an offer catalog, and to combine the ranked dynamic content and the metadata. The email content optimizer may be configured to receive the combined ranked dynamic content and the metadata, and to populate the placeholders in the email template with the dynamic content and the metadata.

In one embodiment, the email content optimizer may be configured to generate a view event in response to the email being opened.

In one embodiment, the email content optimizer may be further configured to monitor a customer interaction with the dynamic content, and to send an activation event in response to the customer selecting the dynamic content in one of the placeholders.

In one embodiment, the email content optimizer may be further configured to redirect the customer to an issuer interface, and the issuer interface may be configured to provide terms and conditions for an offer associated with the selected dynamic content.

In one embodiment, the recommendation engine may be trained based on acceptance or rejection of the offer.

In one embodiment, the static content may include images or customer information for the customer.

In one embodiment, each of the scripts may include Application Programming Interface calls for the dynamic content.

In one embodiment, the third-party aggregators may be configured to identify the dynamic content based on transaction files for the customer received from an issuer.

In one embodiment, the recommendation engine may be configured to rank the dynamic content based on the customer's transaction history, offers made to the customer, and offers redeemed by the customer.

In one embodiment, the metadata may include an offer start date, and offer expiration date, details for the offer, and offer vendor information.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for integrating third party offers from multiple aggregators into a single message according to an embodiment;

FIG. 2 illustrates a method for integrating third party offers from multiple aggregators into a single message according to an embodiment;

FIG. 3 depicts an exemplary computing system for implementing aspects of the present disclosure.

### DETAILED DESCRIPTION OF PREFERRED EMBODIMENTS

Systems and methods for integrating third party offers from multiple aggregators into a single message are disclosed. In embodiments, the offers may be personalized to the receiver. Further, the personalization and ranking of the third-party offers may be done in real-time.

Embodiments may include an abstraction layer that combines offers from multiple offer aggregators. The abstraction layer may use machine learning capabilities to personalize offers based on customer preferences and in real-time when a customer opens a message, such as an email, including an offer.

Embodiments may capture customer engagement data for analytics that feed into machine learning and further develop personalization capabilities.

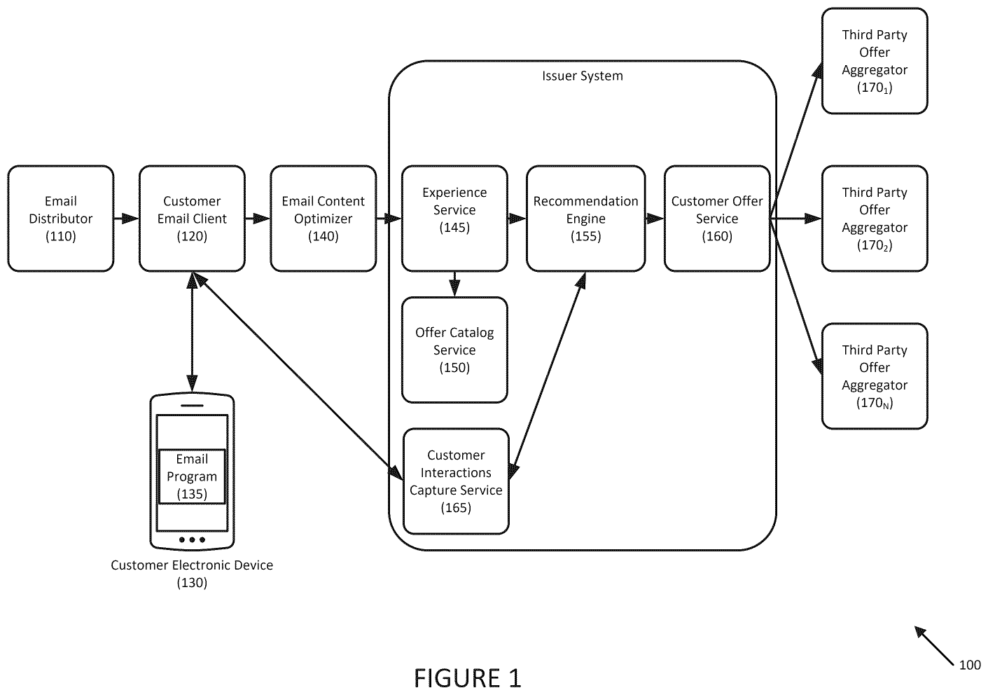

Referring to FIG. 1, a system for integrating third party offers from multiple aggregators into a single message is disclosed according to an embodiment. System 100 may include email distributor 110, customer email client 120, customer electronic device 130 executing email program 135, email content optimizer 140, experience service 145, offer catalog service 150, recommendation engine 155, customer offer service 160, and third party offer aggregators 170₁, 170₂, . . . 170_{N}.

Email distributor 110 may be an entity that prepares email templates and broadcasts emails to targeted customers for an organization. It may provide the email templates and emails to customer email client 120.

Customer email client 120 may be a service that distributes emails to email program 135 executed by customer electronic device 130, such as computers (e.g., workstations, desktops, laptops, notebooks, tablets, etc.), smart devices (e.g., smartphones, smart watches, etc.), Internet of Things (IoT) appliances, etc.

Email content optimizer 140 may be an entity that connects with experience service 145 in real-time to retrieve offer content for targeted customers. Experience service 145 may include an Application Programming Interface (API) that may be hosted by an organization that connects with different third party offer aggregators 170 in real-time and may use a personalization engine. It may further receive emails and templates from customer email client 120.

Offer catalog service 150 may provide offer details, including offer identifiers associated with the offers, metadata related to the offers, etc. Offer catalog service 150 may read catalog data that may be stored by an organization. The catalog data may be periodically refreshed via a feed from one or more of third party offer aggregators 170. The catalog data may include, for example, data relating to each offer from third party offer aggregators 170, such as the vendor logo, a discount percentage, a location, offer type (e.g., online or offline), etc.

Experience service 145 may call offer catalog service 150.

Recommendation engine 155 may include a personalization engine that utilizes customer engagement data, purchase history, offer redemptions, and any other suitable data attributes with machine learning capabilities to provide personalization of offers and offer ranking for customers. It may receive calls from experience service 145.

Customer offer service 160 may receive a list of offer identifiers that may be identified for a particular targeted customer from different third party offer aggregators 170. It may further receive calls from recommendation engine 155.

Third party offer aggregators 170₁, 170₂, . . . 170_{N} may provide merchant offer services to organizations.

The issuer system may include experience service 145, offer catalog service 150, recommendation engine 155, customer offer service, and customer interactions capture service 165. Customer interactions capture service 165 may be an API that captures customer engagement from the email delivered to their inbox. The data captured from the API feeds into recommendation engine and is one of the several data attributes used to determine personalized offers.

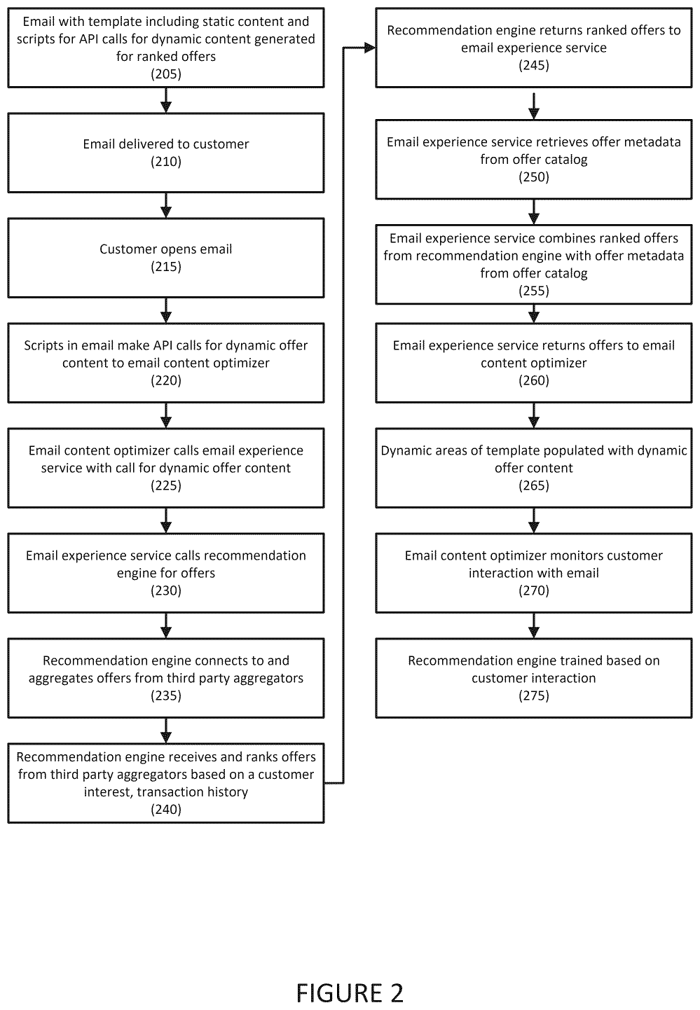

Referring to FIG. 2, a method for integrating third party offers from multiple aggregators into a single message is disclosed according to an embodiment.

In step 205, an email distributor may generate an offer email using a template. The template may include static content, such as images, customer information, etc. The template may include placeholders for static content, as well as scripts for API calls for dynamic content, such as dynamic offer content.

In step 210, the email distributor may send the email to the customer using, for example, a customer email client. The email may be delivered to the customer's electronic device.

In step 215, the customer may open or otherwise access the email.

In step 220, in response to the customer opening or accessing the email, the scripts in template may make API calls for the dynamic offer content to an email content optimizer.

In step 225, the email content optimizer calls may call an email experience service with a call for the dynamic offer content.

In step 230, the email experience service may call a recommendation engine for the dynamic offer content, which, in step 235, may then call third-party aggregators for the dynamic offer content. In one embodiment, the recommendation engine may use an internal orchestrator API, such as a customer offer service, to connect to and to aggregate dynamic offers content from the third-party vendors.

In one embodiment, the third-party aggregators may periodically receive customer credit and debit transactions files as well as customer interactions with offers on web and mobile platforms. The third-party aggregators may use this information to identify offers to return to the recommendation engine.

In one embodiment, the third party offer aggregators may return the offer identifiers associated with the offers.

In step 240, the recommendation engine may rank the offers received from the customer offer service based on, for example, the customer's transaction history, prior offers made to the customer using the personalization engine, recommended offers redeemed by the customer, customer behavior on the issuer's mobile and web platforms, etc.

In step 245, the recommendation engine may return the ranked offers to the email experience service.

In step 250, the email experience service may retrieve offer metadata from the offer catalog. This may be done in parallel with step 230, above. For example, the offer catalog service may provide the offers and metadata relating to offers. Examples of metadata may include an offer start date, and offer expiration date, details for the offer, and offer vendor information (e.g., vendor name, logo, etc.).

In step 255, the email experience service may combine the response from the recommendation engine with the response from the offer catalog.

In step 260, the email experience service may return the dynamic offer content to the email content optimizer, and in step 265, the email content optimizer may populate the dynamic areas of the template with the dynamic offer content.

In step 270, the email content optimizer may monitor the customer's interaction with email, such as whether the customer selects dynamic offer content, whether the customer hovers over certain dynamic content, etc. For example, when an email is opened, the email content optimizer may send “view” events from the template to an interface, such as a customer interactions capture service.

In one embodiment, when a customer clicks on an offer displayed in the template to activate the offer, an “activation” event is sent to the customer interactions capture service. For example, as a result of clicking the offer, the customer may be directed to the issuer's mobile or web homepage for sign-in, and once signed-in, the full terms and conditions for the offer may be provided.

In step 275, the recommendation engine may be trained based on the customer interaction with the email, mobile platform, or web interface. For example, the customer's engagement may be used to measure the effectiveness of the email campaigns. When a customer clicks on an offer but does not sign-in, it is considered a “drop,” and this may be used to inform future email campaigns and/or to better target the customer.

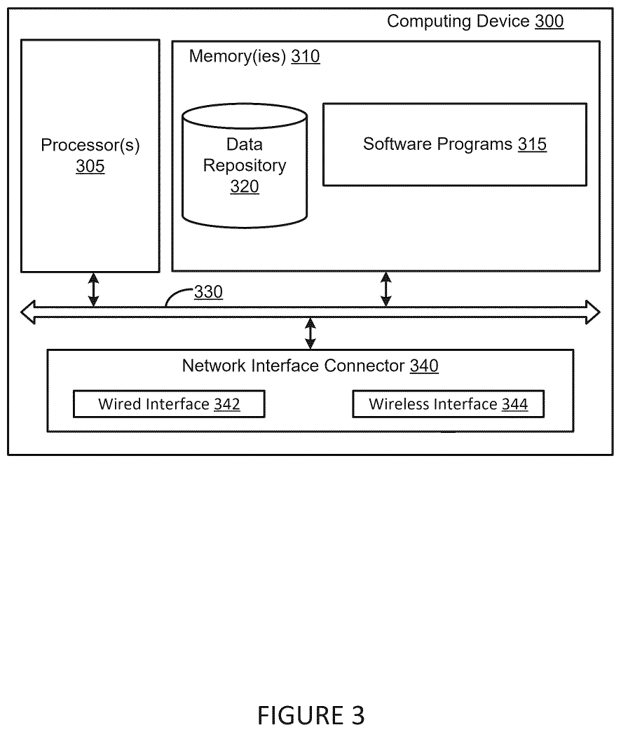

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
generating, by an email distributor, an email using a template, the template comprising static content and placeholders for dynamic content, the placeholders comprising scripts for calling the dynamic content;
sending, by the email distributor, the email to a customer using a customer email client;
in response to the email being opened:
executing, by a computer processor on a customer electronic device, the scripts, wherein the scripts call an email content optimizer for the dynamic content;
calling, by the email content optimizer, an email experience service with the calls for the dynamic content;
requesting, by the email experience service, a recommendation engine for the dynamic offer content, wherein the recommendation engine calls a plurality of third-party aggregators for the dynamic content;
ranking, by the recommendation engine, the dynamic content;
receiving, by the email experience service, the ranked dynamic content;
retrieving, by the email experience service, metadata for the dynamic content from an offer catalog;
combining, by the email experience service, the ranked dynamic content and the metadata;
receiving, by the email content optimizer, the combined ranked dynamic content and the metadata; and
populating, by the email content optimizer, the placeholders in the email template with the dynamic content and the metadata.

2. The method of claim 1, wherein the email content optimizer generates a view event in response to the email being opened.

3. The method of claim 1, further comprising:
monitoring, by the email content optimizer, customer interaction with the dynamic content; and
sending, by the email content optimizer, an activation event in response to the customer selecting the dynamic content in one of the placeholders.

4. The method of claim 3, further comprising:
redirecting, by the email content optimizer, the customer to an issuer interface;
wherein the issuer interface provides terms and conditions for an offer associated with the selected dynamic content.

5. The method of claim 4, further comprising:
training the recommendation engine based on acceptance or rejection of the offer.

6. The method of claim 1, wherein the static content comprises images or customer information for the customer.

7. The method of claim 1, wherein each of the scripts comprises Application Programming Interface calls for the dynamic content.

8. The method of claim 1, wherein the third-party aggregators identify the dynamic content based on transaction files for the customer received from an issuer.

9. The method of claim 1, wherein the recommendation engine ranks the dynamic content based on the customer's transaction history, offers made to the customer, and offers redeemed by the customer.

10. The method of claim 1, wherein the metadata comprises an offer start date, and offer expiration date, details for the offer, and offer vendor information.

11. A system, comprising:
an email distributor that is configured to generate an email using a template, the template comprising static content and placeholders for dynamic content, the placeholders comprising scripts for calling the dynamic content, and to send email to a customer using a customer email client;
a customer electronic device executing an email program;
an email content optimizer;
an email experience service;
a recommendation engine; and
a plurality of third-party aggregators;
wherein:
the email program is configured to execute the scripts in response to the email being opened, wherein the scripts call the email content optimizer for the dynamic content;
the email content optimizer is configured to call an email experience service with the calls for the dynamic content;
the email experience service is configured to call the recommendation engine for the dynamic offer content;
the recommendation engine is configured to call a plurality of third-party aggregators for the dynamic content;
the recommendation engine is configured to rank the dynamic content;
the email experience service is configured to receive the ranked dynamic content, to retrieve metadata for the dynamic content from an offer catalog, and to combine the ranked dynamic content and the metadata;
the email content optimizer is configured to receive the combined ranked dynamic content and the metadata, and to populate the placeholders in the email template with the dynamic content and the metadata.

12. The system of claim 11, wherein the email content optimizer is configured to generate a view event in response to the email being opened.

13. The system of claim 11, wherein the email content optimizer is further configured to monitor a customer interaction with the dynamic content, and to send an activation event in response to the customer selecting the dynamic content in one of the placeholders.

14. The system of claim 13, wherein the email content optimizer is further configured to redirect the customer to an issuer interface, and the issuer interface is configured to provide terms and conditions for an offer associated with the selected dynamic content.

15. The system of claim 14, wherein the recommendation engine is trained based on acceptance or rejection of the offer.

16. The system of claim 11, wherein the static content comprises images or customer information for the customer.

17. The system of claim 11, wherein each of the scripts comprises Application Programming Interface calls for the dynamic content.

18. The system of claim 11, wherein the third-party aggregators are configured to identify the dynamic content based on transaction files for the customer received from an issuer.

19. The system of claim 11, wherein the recommendation engine is configured to rank the dynamic content based on the customer's transaction history, offers made to the customer, and offers redeemed by the customer.

20. The system of claim 11, wherein the metadata comprises an offer start date, and offer expiration date, details for the offer, and offer vendor information.
